(19) United States
(12) Patent Application Publication
(10) Pub. No.: US 2026/0237784 A1
(43) Pub. Date: Aug. 13, 2026

(54) BATTERY COOLING PLATE STRUCTURE FOR HEAVY DUTY APPLICATION

(71) Applicant: LG ENERGY SOLUTION, LTD., Seoul (KR)

(72) Inventors: Atish DAHITULE, Troy, MI (US); Hee Kook YANG, Sterling Heights, MI (US); Arvind Srivatsan VARADHARAJAN, Troy, MI (US)

(73) Assignee: LG ENERGY SOLUTION, LTD., Seoul (KR)

(21) Appl. No.: 19/048,291

(22) Filed: Feb. 7, 2025

(51) Int. Cl. H01M 10/6556; H01M 10/613; H01M 10/617; H01M 10/6567

(52) U.S. Cl. CPC H01M 10/6556; H01M 10/613; H01M 10/617; H01M 10/6567

(57) ABSTRACT

A cooling plate assembly may include a top plate, a bottom plate, a cooling channel disposed between the top plate and the bottom plate, an inlet port, and an outlet port. The cooling channel may include an inlet channel coupled to the inlet port, an outlet channel coupled to the outlet port, a splitting channel disposed downstream of the inlet channel and configured to divide the flow path into a first split path and a second split path, a plurality of first split path channels disposed between the splitting channel and the outlet channel, and a plurality of second split path channels disposed between the splitting channel and the outlet channel. The first split path and the second split path may meet at the outlet channel.

### TECHNICAL FIELD

Various embodiments of the present disclosure relate generally to a cooling plate assembly for a battery unit and a battery system including the same.

### BACKGROUND

Batteries are increasingly being integrated into a wide range of mobile devices, including smartphones, laptops, electric vehicles (EVs), hybrid electric vehicles (HEVs), plug-in hybrid electric vehicles (PHEVs), and energy storage systems (ESS). Batteries may generate significant heat during operation, which can adversely affect performance, longevity, and safety. Overheating can lead to various problems, including reduced battery capacity, shortened lifespan, and various safety issues.

Therefore, effective cooling solutions are essential for maintaining optimal operating temperatures, enhancing battery life, and ensuring safe usage. One option for the cooling solutions may be cooling plates that are designed to dissipate heat generated during battery operation. The cooling plates may prevent overheating and ensure optimal performance. As energy storage requirements continue to increase across various applications, particularly in electric vehicles and grid storage systems, the demand for more efficient and reliable cooling plate designs has become increasingly significant.

### SUMMARY OF THE DISCLOSURE

According to certain aspects of the disclosure, a cooling plate assembly for a battery unit and a battery system including the same are disclosed.

For instance, a cooling plate assembly may include a top plate, a bottom plate, a cooling channel disposed between the top plate and the bottom plate and configured to provide a flow path for a coolant, an inlet port coupled to the cooling channel and configured to receive the coolant, and an outlet port coupled to the cooling channel and configured to output the coolant, wherein the cooling channel comprises an inlet channel coupled to the inlet port, an outlet channel coupled to the outlet port, a splitting channel disposed downstream of the inlet channel and configured to divide the flow path into a first split path and a second split path, a plurality of first split path channels disposed between the splitting channel and the outlet channel, wherein the first split path channels comprise a plurality of elongate first split path channels, and one or more flow rerouting first split path channels, a plurality of second split path channels disposed between the splitting channel and the outlet channel, wherein the second split path channels comprise a plurality of elongate second split path channels, and one or more flow rerouting second split path channels, wherein the first split path and the second split path meet at the outlet channel, wherein at least one of the elongate first split path channels is substantially in parallel with at least one of the elongate second split path channels, and wherein a length of at least one of the elongate second split path channels is greater than a length of a longest elongate first split path channel among the elongate first split path channels.

A thermal management plate assembly may include a top plate, a bottom plate, a channel disposed between the top plate and the bottom plate and configured to provide a flow path for a liquid, an inlet port coupled to the channel and configured to receive the liquid; and an outlet port coupled to the channel and configured to output the liquid, wherein the channel comprises an inlet channel coupled to the inlet port, an outlet channel coupled to the outlet port, a splitting channel disposed downstream of the inlet channel and upstream of the outlet channel, wherein the splitting channel is configured to divide the flow path into a first split path and a second split path, a plurality of first split path channels disposed between the splitting channel and the outlet channel, wherein the first split path channels comprise a plurality of elongate first split path channels, and one or more flow rerouting first split path channels, a plurality of second split path channels disposed between the splitting channel and the outlet channel, wherein the second split path channels comprise a plurality of elongate second split path channels, and one or more flow rerouting second split path channels, wherein the inlet channel includes a deep recess portion having a depth deeper than a depth of other portions of the channel, wherein the inlet port comprises a first end portion and a second end portion closer to the channel than the first end portion, wherein, when viewed from a top, the second end portion of the inlet port overlays the deep recess portion of the inlet channel.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A is a perspective view of a cooling plate assembly according to an example of the present disclosure. FIG. 1B is an exploded view of the cooling plate assembly of FIG. 1A.

FIGS. 2A, 2B, and 3 are a top view of the cooling plate assembly of FIG. 1A with a top plate omitted for clarity.

FIG. 4A is an expanded view of a splitting channel of a cooling channel in the cooling plate assembly of FIG. 1A.

FIG. 4B is an expanded view of an outlet channel of a cooling channel in the cooling plate assembly of FIG. 1A.

FIG. 4C is an expanded view of a portion of a cooling channel in the cooling plate assembly of FIG. 1A.

FIG. 4D is an expanded view of an inlet channel of a cooling channel in the cooling plate assembly of FIG. 1A.

FIG. 4E is a partial view of the cooling plate assembly of FIG. 1A (right) and an expanded view of a portion of a top plate of the cooling plate assembly (left).

FIG. 4F is a cross-sectional view of a portion of the cooling plate assembly of FIG. 4E taken along the line of 4F-4F.

FIG. 5 illustrates a battery system having battery units disposed on the cooling plate assembly of FIG. 1A.

FIG. 6A illustrates an example velocity map showing a change in the velocity of a coolant flow through a cooling channel of a cooling plate assembly according to an example of the present disclosure. FIG. 6B illustrates an example heat map showing a change in temperature across battery units 1, 2, and 3 disposed on an upper portion, a middle portion, and a lower portion, respectively, of a cooling plate assembly according to an example of the present disclosure.

FIG. 7A illustrates an example pressure map showing a change in pressure near an inlet channel of a cooling plate assembly according to an example of the present disclosure, where a deep recess portion and an inlet extender are provided near the inlet channel. FIG. 7B illustrates an example pressure map showing a change in pressure near an inlet channel of a cooling plate assembly according to a comparative example, where no deep recess portion or inlet extender is provided near the inlet channel.

FIG. 8A illustrates example temperature maps showing a change in the temperature of a coolant/cooling channel of Comparative Sample 1 and Samples 1, 2, 3 according to an example of the present disclosure.

FIG. 8B illustrates example temperature maps showing a change in the temperature of a top plate of Comparative Sample 1 and Samples 1, 2, 3 according to an example of the present disclosure.

### DETAILED DESCRIPTION OF EMBODIMENTS

In general, the present disclosure is directed to a cooling plate assembly for a battery unit and a battery system including the same.

Aspects of the present disclosure may provide a cooling plate assembly using liquid coolant to extract heat from battery units to enhance the battery performance. The flow channel design of the cooling plate assembly may provide uniform temperature distribution across the plate surface with high heat transfer potential. For example, the cooling plate assembly may exchange heat by using indirect liquid cooling mechanism (liquid coolant flowing inside a cooling channel). The cooling channel design of the cooling plate assembly according to an example of the present disclosure may minimize the temperature difference across the cooling plate assembly.

In addition, the cooling plate assembly according to an example of the present disclosure may include various features that may keep the pressure drops within acceptable limits and allow for better mixing of the fluid while providing the structural rigidity to the cooling plate assembly. For example, aspects of the present disclosure may provide a deep recess portion having a deeper depth than other portions of the cooling channel and disposed near the inlet port/inlet channel, which may help reduce the pressure drop near the inlet port/inlet channel. The cooling plate assembly according to an example of the present disclosure may also include supporting protrusions in the cooling channel, which may increase the structural rigidity of the cooling plate assembly to withstand high internal operating pressures and improve the mixing of the coolant, thereby enabling robust heat transfer process.

The cooling plate assembly according to an example of the present disclosure may also serve as a structural support for the battery pack structure, thereby reducing the need for additional structural components and overall weight of the battery assembly. In this way, aspects of the present disclosure may provide an enhanced cooling plate assembly that can provide balanced performance with uniform temperature distribution across the battery units and optimal pressure drop with structural support to contribute higher energy density, which is critical for large battery applications, such as heavy-duty truck.

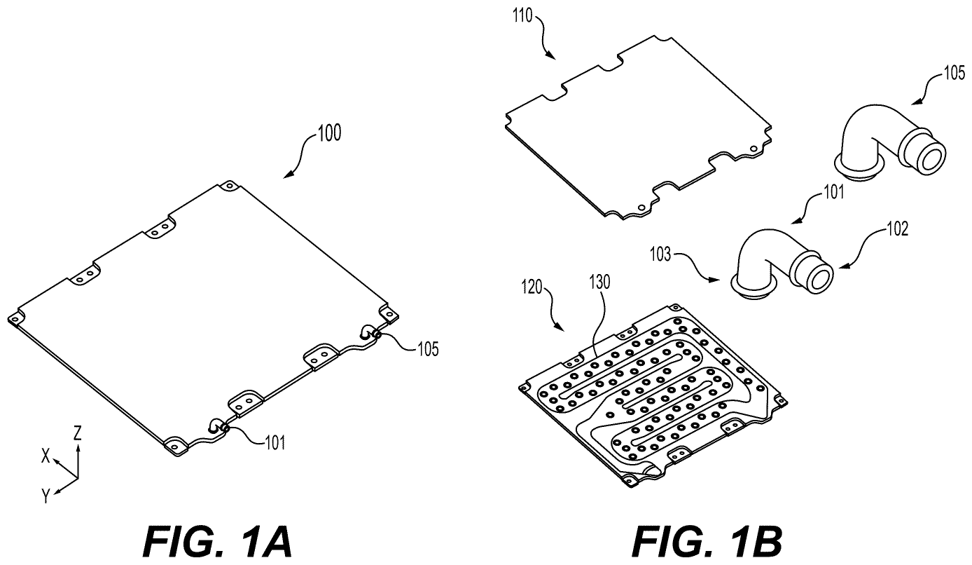

FIG. 1A is a perspective view of a cooling plate assembly 100 according to an example of the present disclosure. FIG. 1B is an exploded view of the cooling plate assembly 100 of FIG. 1A. The cooling plate assembly 100 may be provided to lower or maintain the temperature of one or more battery units adjacent the cooling plate assembly, for example, using a coolant circulated in the cooling pate assembly 100.

In some examples, each battery unit may have a module design. For example, each battery unit of a battery pack may be a battery module. Each battery module may include a plurality of battery cells. In other examples, each battery unit may have a moduleless design. In this case, each battery unit of a battery pack may include one or more battery cells within the battery pack, for example, without a module package/housing therebetween.

In some examples, the number of battery cells in each battery unit may be in a range of 2 to 4096 battery cells. For example, each battery unit may include 2, 4, 8, 16, 32, 64, 128, 256, 512, 1024, 2048, or 4096 battery cells. In other examples, each battery unit may include any other suitable number of battery cells.

As shown in FIGS. 1A and 1B, the cooling plate assembly 100 may include a top plate 110, a bottom plate 120, a cooling channel 130, an inlet port 101, and an outlet port 105.

In some examples, the top plate 110 and the bottom plate 120 may be made of metals and alloys, such as aluminum, aluminum alloys, stainless steel, copper, and/or silver. For example, the top plate 110 and the bottom plate 120 may be made of aluminum alloys, following the ANSI/AA (American National Standards Institute/Aluminum Association) numbering system (e.g., AAYXXX, where Y varies from 1-8 and AA stands for aluminum alloy). In other examples, the top plate 110 and the bottom plate 120 may be made of any other suitable material (e.g., any material having a high thermal conductivity). In some examples, a thickness of the top plate 110 may be in a range of about 1.5 mm to 3.0 mm. In other examples, the top plate 110 may have any other suitable thickness. In some examples, a thickness of the bottom plate 120 may be in a range of about 1.0 mm to 3.0 mm. In other examples, the bottom plate 120 may have any other suitable thickness.

The cooling channel 130 may be disposed between the top plate 110 and the bottom plate 120. In some examples, the cooling channel 130 may be formed on the bottom plate 120. For example, the cooling channel 130 may be carved on the bottom plate 120 (e.g., by forming a groove on the bottom plate 120), and the top plate 110 may serve as a top housing of the cooling channel 130. The cooling channel 130 may provide a flow path for a coolant. Examples of the coolant may include industrial grade chemical compounds like ethylene glycol with relatively low-melting point.

The inlet port 101 and the outlet port 105 may be coupled to the cooling channel 130. The inlet port 101 may be provided to receive the coolant, and the outlet port 105 may be provided to output the coolant. For example, the coolant may enter into the cooling channel 130 via the inlet port 101 and may exit the cooling channel 130 via the outlet port 105.

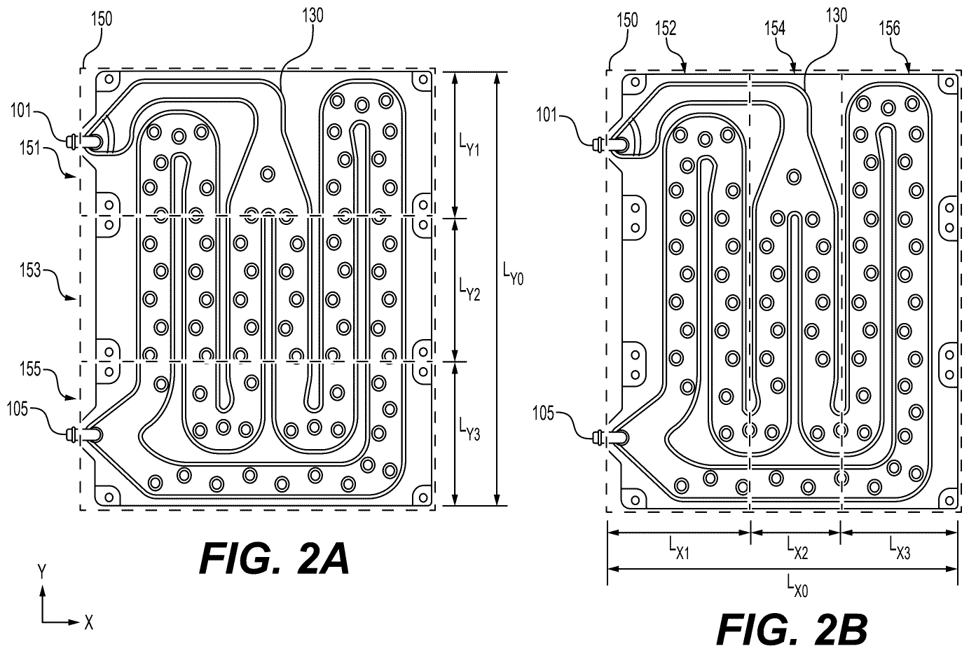

FIGS. 2A and 2B are a top view of the cooling plate assembly 100. In FIGS. 2A and 2B, the top plate 110 is omitted for purposes of clarity. Referring to FIGS. 1A, 2A, and 2B, in some examples, the cooling plate assembly 100 may extend in a direction of a first axis (e.g., x-axis). A length L_{X0} of the cooling plate assembly 100 in the direction of the first axis may be in a range of about 675 mm to about 700 mm. In some examples, the cooling plate assembly 100 may extend in a direction of a second axis (e.g., y-axis). A length L_{Y0} of the cooling plate assembly 100 in the direction of the second axis may be in a range of about 700 mm to about 750 mm. In some examples, an angle formed between the first axis and the second axis may be in a range of about 60 degrees to about 120 degrees. In other examples, the angle formed between the first axis and the second axis may have any other suitable value.

In some examples, the cooling plate assembly 100 may extend in a direction of a third axis (e.g., z-axis). The third axis may be perpendicular to the first axis and the second axis. A thickness of the cooling plate assembly 100 in the direction of the third axis may be in a range of about 3.0 mm to about 7.0 mm.

In some examples, when viewed from a top (e.g., from the third axis), the cooling plate assembly 100 may define a virtual quadrangle 150. The virtual quadrangle 150 may be defined as a smallest quadrangle that can include the entire cooling plate assembly 100 (except for the inlet port 101 and the outlet port 105). In some examples, the length L_{X0} of the cooling plate assembly 100 in the direction of the first axis may refer to the length of the virtual quadrangle 150 in the direction of the first axis. Similarly, the length L_{Y0} of the cooling plate assembly 100 in the direction of the second axis may refer to the length of the virtual quadrangle 150 in the direction of the second axis.

The virtual quadrangle 150 may include an upper portion 151, a lower portion 155, and a middle portion 153 between the upper portion 151 and the lower portion 155. In some examples, a length L_{Y1} of the upper portion 151 in the direction of the second axis (e.g., y-axis) may be around 25% to 40% of L_{Y0}. In other examples, the upper portion 151 may have any other suitable length in the direction of the second axis. In some examples, a length L_{Y2} of the middle portion 153 in the direction of the second axis (e.g., y-axis) may be around 25% to 40% of L_{Y0}. In other examples, the middle portion 153 may have any other suitable length in the direction of the second axis. In some examples, a length L_{Y3} of the lower portion 155 in the direction of the second axis (e.g., y-axis) may be around 25% to 40% of L_{Y0}. In other examples, the lower portion 155 may have any other suitable length in the direction of the second axis.

The virtual quadrangle 150 may also include a left portion 152, a right portion 156, and an intermediate portion 154 between the left portion 152 and the right portion 156. In some examples, a length L_{X1} of the left portion 152 in the direction of the first axis (e.g., x-axis) may be around 25% to 50% of L_{X0}. In other examples, the left portion 152 may have any other suitable length in the direction of the first axis. In some examples, a length L_{X2} of the intermediate portion 154 in the direction of the first axis (e.g., x-axis) may be around 20% to 40% of L_{X0}. In other examples, the intermediate portion 154 may have any other suitable length in the direction of the first axis. In some examples, a length L_{X3} of the right portion 156 in the direction of the first axis (e.g., x-axis) may be around 25% to 40% of L_{X0}. In other examples, the right portion 156 may have any other suitable length in the direction of the first axis.

In some examples, when viewed from the top, the upper portion 151, middle portion 153, and/or lower portion 155 may include an empty portion 157 that is not occupied by the cooling plate assembly 100. The empty portion of the upper portion 151, middle portion 153, and/or lower portion 155 may be less than 10%, 7%, 5%, or 3% of the upper portion 151, middle portion 153, and/or lower portion 155. Similarly, in some examples, when viewed from the top, the left portion 152, intermediate portion 154, and/or right portion 156 may include an empty portion that is not occupied by the cooling plate assembly 100. The empty portion of the left portion 152, intermediate portion 154, and/or right portion 156 may be less than 10%, 7%, 5%, or 3% of the left portion 152, intermediate portion 154, and/or right portion 156.

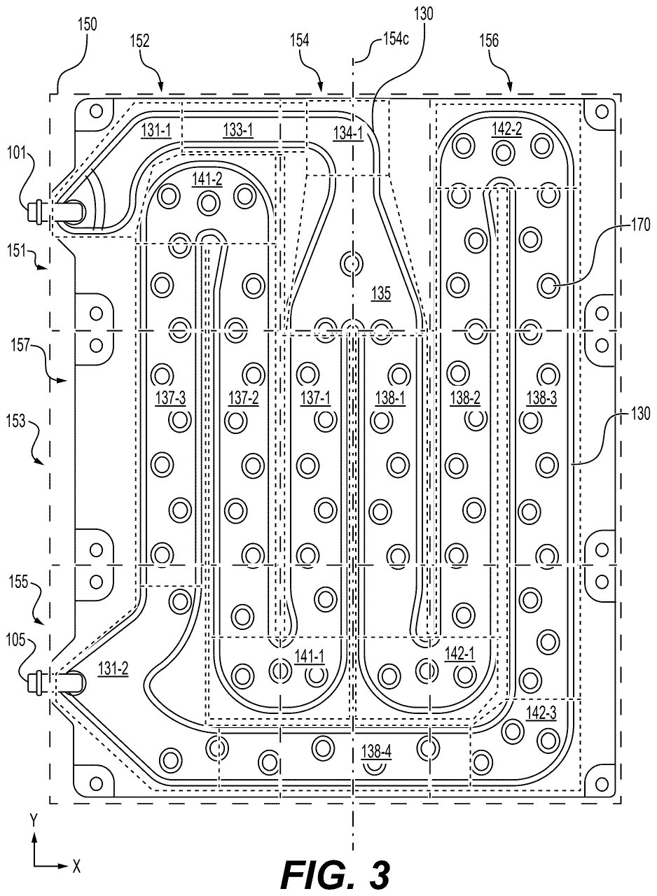

In some examples, the inlet port 101 and/or the inlet channel 131-1 may be disposed in the upper portion 151 and the left portion 152. The outlet port 105 and/or the outlet channel 131-2 may be disposed in the lower portion 155 and the left portion 152. In some examples, the inlet port 101 and the outlet port 105 may be disposed on the left edge portion. In other examples, the inlet port 101 and the outlet port 105 may be disposed on any other suitable portion of the cooling plate assembly 100 (e.g., upper edge portion, right edge portion, bottom edge portion). In some examples, the inlet port 101 and the outlet port 105 may be disposed on the same edge portion, as shown in FIG. 3. In other examples, the inlet port 101 and the outlet port 105 may be disposed on different edge portions.

In some examples, the top plate 110 and/or the bottom plate 120 may be substantially in a rectangular shape, as shown in FIGS. 1A, 1B, 2A, and 2B. In this case, the virtual quadrangle 150 may be in a rectangular shape. The top plate 110 and/or the bottom plate 120 may include one or more protrusions (when viewed from the top) for areas for the inlet port 101 and/or the outlet port 105.

Referring to FIG. 3, in some examples, the cooling channel 130 may include an inlet channel 131-1 coupled to the inlet port 101 and an outlet channel 131-2 coupled to the outlet port 105. In some examples, the inlet channel 131-1 may refer to a portion of the cooling channel 130 within a predetermined distance from the inlet port 101. The predetermined distance may be in a range of about 150 mm to about 200 mm. In some examples, the out channel 131-2 may refer to a portion of the cooling channel 130 within a predetermined distance from the outlet port 105. The predetermined distance may be in a range of about 170 mm to about 220 mm.

In some examples, the cooling channel 130 may further include a splitting channel 135 disposed downstream of the inlet channel 131-1 and upstream of the outlet channel 131-2. In some examples, the splitting channel 135 may be disposed only in the intermediate portion 154. In other examples, the splitting channel 135 may be disposed in at least one of the left portion 152, intermediate portion 154, and right portion 156. In some examples, the splitting channel 135 may be disposed only in the upper portion 151. In other examples, the splitting channel 135 may be disposed in at least one of the upper portion 151, middle portion 153, and lower portion 155.

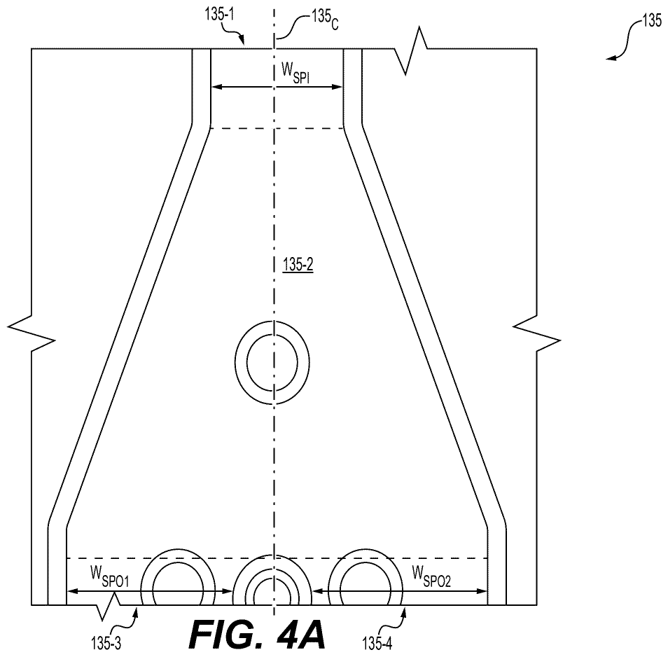

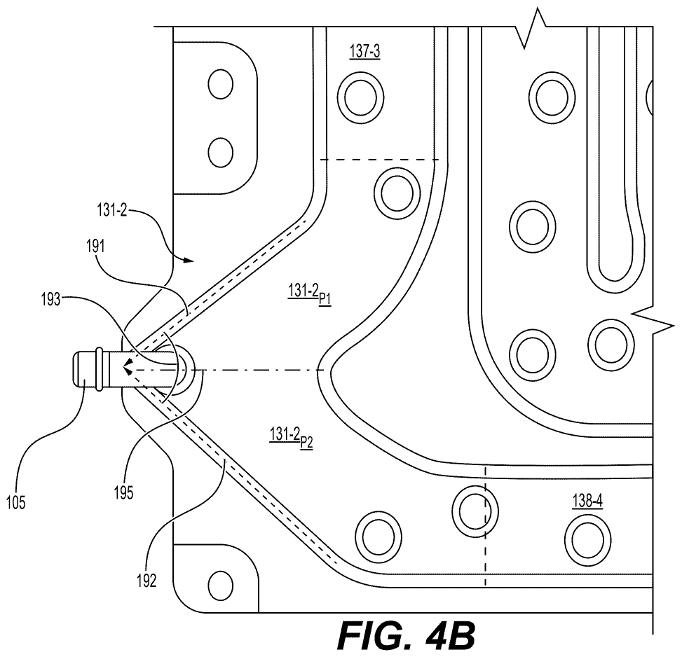

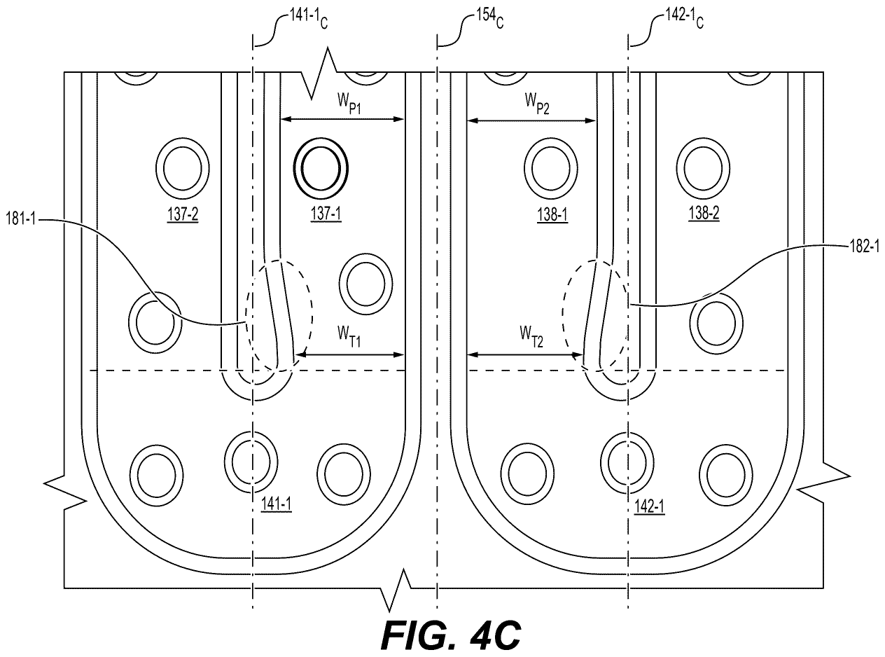

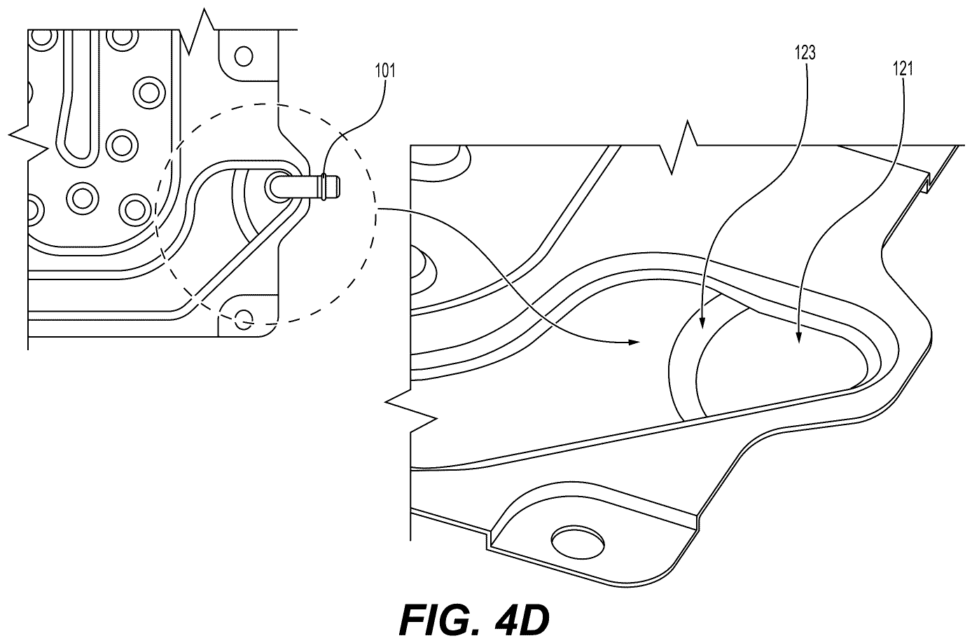

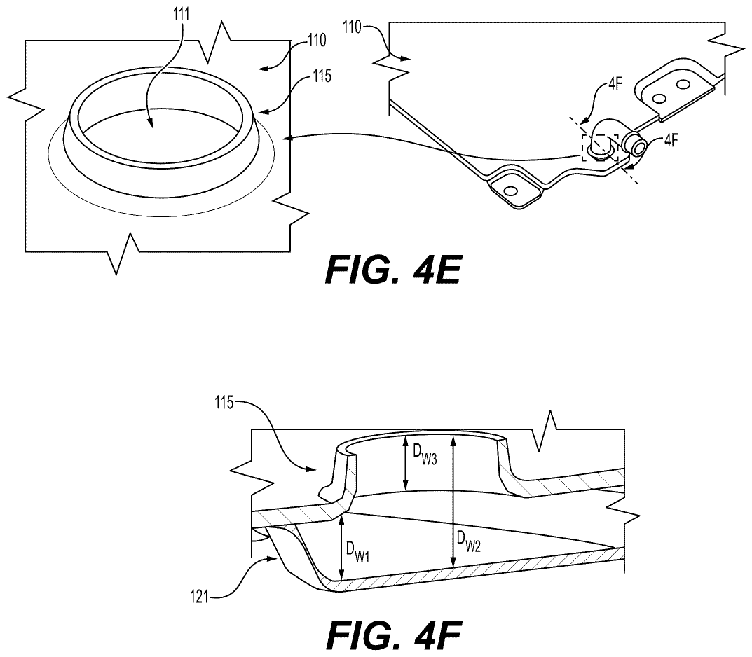

The splitting channel 135 may divide the flow path into multiple different split paths. Referring to FIG. 4A, the splitting channel 135 may include a split inlet channel portion 135-1 configured to receive the coolant from the inlet channel 131-1, a plurality of split outlet channel portions configured to output the coolant, and a split body channel portion 135-2 disposed between the split inlet channel portion 135-1 and the split outlet channel portions.

In some examples, the split body channel portion 135-2 may be tapered to have a wider width from the split inlet channel portion 135-1 toward the split outlet channel portions. In some examples, the splitting channel 135 may define a central axis 135_{C} and the splitting channel 135, including the split inlet channel portion 135-1, split body channel portion 135-2, split outlet channel portions, may be symmetrical with respect to the central axis 135_{C}. The intermediate portion 154 may define a central axis 154_{C}. In some examples, the central axis 154_{C} of the intermediate portion 154 may be co-axial with the central axis 135_{C} of the splitting channel 135.

In some examples, a width W_{SPI} of the split inlet channel portion 135-1 may be narrower than a width W_{SPOn} of each of the split outlet channel portions. In other examples, the width W_{SPI} of the split inlet channel portion 135-1 may be narrower than the width W_{SPOn} of at least one of the split outlet channel portions, and equal to or wider than the width W_{SPOn} of at least one of the split outlet channel portions. In some examples, the width W_{SPOn} of the split outlet channel portions may be the same as each other. In other examples, the width W_{SPOn} of the split outlet channel portions may be different from each other. As used herein, the term “width” of a channel may refer to a length of the channel in a direction perpendicular to the flow direction of the liquid/coolant along the channel.

In some examples, the split outlet channel portions may include a first split outlet channel portion 135-3 and a second split outlet channel portion 135-4. The first split outlet channel portion 135-3 may be configured to output a portion of the coolant along the first split path. The second split outlet channel portion 135-4 may be configured to output a portion of the coolant along the second split path. Although only two split outlet channel portions are shown, the splitting channel 135 may include more than two split outlet channel portions (e.g., 3, 4, 5, . . . ).

In some examples, the cooling channel 130 may include a plurality of split path channels disposed between the splitting channel 135 and the outlet channel 131-2. The cooling channel 130 may include a plurality of split path channels between the split outlet channel portions and the outlet channel 131-2. For example, the cooling channel 130 may include a plurality of first split path channels between the first split outlet channel portion 135-3 and the outlet channel 131-2 and a plurality of second split path channels between the second split outlet channel portion 135-4 and the outlet channel 131-2.

Each of the split path channels may include one or more elongate split path channels and/or one or more flow rerouting split path channels. For example, the first split path channels may include one or more elongate first split path channels 137-n and/or one or more flow rerouting first split path channels 141-n. Similarly, the second split path channels may include one or more elongate second split path channels 138-n and/or one or more flow rerouting second split path channels 142-n.

As used herein, the term “elongate” may mean having one dimension (e.g., length) that is substantially greater (e.g., at least two times, three times, four times, or more) than other dimensions (e.g., width or height). The one or more elongate split path channels may have a (substantially) straight shape in a length direction. The one or more elongate split path channels may be configured to allow the coolant to have a substantially direct (or straight) flow along the respective split path without any rerouting (e.g., change of the course/direction of the flow). In some examples, the split paths may meet at the outlet channel 131-2. For example, the first split path and the second split path may meet at the outlet channel 131-2.

In some examples, at least one of the elongate split path channels from one split path may be substantially in parallel with at least one of the elongate split path channels from another split path. For example, at least one of the elongate first split path channels (137-n) may be substantially in parallel with at least one of the elongate second split path channels (138-n). In some examples, all of the elongate split path channels from one split path may be substantially in parallel with all of the elongate split path channels from another split path. For example, all of the elongate first split path channels (137-n) may be substantially in parallel with all of the elongate second split path channels (138-n), as shown in FIG. 3.

In some examples, a length of at least one of the elongate split path channels from one split path may be greater than a length of a longest elongate split path channel of another split path. For example, a length of at least one of the elongate second split path channels 138-n may be greater than a length of a longest elongate first split path channel among the elongate first split path channels 137-n.

In some examples, an arrangement of the plurality of first split path channels and an arrangement of the plurality of second split path channels may be asymmetrical with respect to the central axis 135_{C} of the splitting channel 135 and/or the central axis 154_{C} of the intermediate portion 154, as shown in FIG. 3. In other examples, the arrangement of the plurality of first split path channels and the arrangement of the plurality of second split path channels may be symmetrical with respect to the central axis 135_{C} of the splitting channel 135 and/or the central axis 154_{C} of the intermediate portion 154.

In some examples, a shortest distance of the second split path channels (e.g., one or more elongate second split path channels 138-n and one or more flow rerouting second split path channels 142-n) along the second split path may be greater than a shortest distance of the first split path channels (e.g., one or more elongate first split path channels 137-n and one or more flow rerouting first split path channels 141-n) along the first split path, as shown in FIG. 3. In other examples, a shortest distance of the second split path channels along the second split path may be equal to or less than a shortest distance of the first split path channels along the first split path.

Referring to FIG. 3, in some examples, the elongate first split path channels 137-n for the first split path may include a first elongate first split path channel 137-1 having a first end portion coupled to the splitting channel 135 (e.g., first split outlet channel portion 135-3) and a second end portion opposite the first end portion. The elongate second split path channels 138-n for the second split path may include a first elongate second split path channel 138-1 having a first end portion coupled to the splitting channel 135 (e.g., second split outlet channel portion 135-4) and a second end portion opposite the first end portion. As used herein, the term “end portion” of an object may refer to a terminal section of the object having a length equal to or less than 10%, 7%, 5%, or 3% of the entire length of the object.

In some examples, the first elongate first split path channel 137-1 and/or the first elongate second split path channel 138-1 may be disposed in at least one of the left portion 152, intermediate portion 154, and right portion 156. For example, the first elongate first split path channel 137-1 and the first elongate second split path channel 138-1 may be disposed in the intermediate portion 154, as shown in FIG. 3. In some examples, the first elongate first split path channel 137-1 and the first elongate second split path channel 138-1 may extend along at least one of the upper portion 151, middle portion 153, and the lower portion 155. For example, the first elongate first split path channel 137-1 and the first elongate second split path channel 138-1 may extend along the middle portion 153 and the lower portion 155, as shown in FIG. 3.

The one or more flow rerouting first split path channels 141-n and the one or more flow rerouting second split path channels 142-n may be configured to reroute a flow of the coolant along the respective split path at a predetermined angle. In some examples, the predetermined angle may be in a range of about 60 degrees to about 190 degrees. In other examples, the predetermined angle may have any other suitable value.

In some examples, the one or more flow rerouting first split path channels 141-n for the first split path may include a first flow rerouting first split path channel 141-1 having a first end portion coupled to the second end portion of the first elongate first split path channel 137-1 and a second end portion opposite the first end portion. The first flow rerouting first split path channel 141-1 may be configured to reroute a flow of the coolant along the first split path at a first predetermined angle. In some examples, the first predetermined angle may be in a range of about 120 degrees to about 190 degrees. In other examples, the first predetermined angle may have any other suitable value.

In some examples, the first flow rerouting first split path channel 141-1 may be disposed in at least one of the upper portion 151, middle portion 153, and the lower portion 155. For example, the first flow rerouting first split path channel 141-1 may be disposed in the lower portion 155, as shown in FIG. 3. In some examples, the first flow rerouting first split path channel 141-1 may be disposed in at least one of the left portion 152, intermediate portion 154, and right portion 156. For example, the first flow rerouting first split path channel 141-1 may be disposed in the left portion 152 and intermediate portion 154, as shown in FIG. 3.

In some examples, the one or more flow rerouting second split path channels 142-n for the second split path may include a first flow rerouting second split path channel 142-1 having a first end portion coupled to the second end portion of the first elongate second split path channel 138-1 and a second end portion opposite the first end portion. The first flow rerouting second split path channel 142-1 may be configured to reroute a flow of the coolant along the second split path at a second predetermined angle. In some examples, the second predetermined angle may be in a range of about 120 degrees to about 190 degrees. In other examples, the second predetermined angle may have any other suitable value.

In some examples, the first flow rerouting second split path channel 142-1 may be disposed in at least one of the upper portion 151, middle portion 153, and the lower portion 155. For example, the first flow rerouting second split path channel 142-1 may be disposed in the lower portion 155, as shown in FIG. 3. In some examples, the first flow rerouting second split path channel 142-1 may be disposed in at least one of the left portion 152, intermediate portion 154, and right portion 156. For example, the first flow rerouting second split path channel 142-1 may be disposed in the intermediate portion 154 and the right portion 156, as shown in FIG. 3.

In some examples, the elongate first split path channels 137-n may further include a second elongate first split path channel 137-2 having a first end portion coupled to the second end portion of the first flow rerouting first split path channel 141-1 and a second end portion opposite the first end portion. The elongate second split path channels 138-n may further include a second elongate second split path channel 138-2 having a first end portion coupled to the second end portion of the first flow rerouting second split path channel 142-1 and a second end portion opposite the first end portion.

In some examples, the second elongate first split path channel 137-2 and/or the second elongate second split path channel 138-2 may be disposed in at least one of the left portion 152, intermediate portion 154, and right portion 156. For example, the second elongate first split path channel 137-2 may be disposed in the left portion 152, and the second elongate second split path channel 138-2 may be disposed in the right portion 156, as shown in FIG. 3. In some examples, the second elongate first split path channel 137-2 and the second elongate second split path channel 138-2 may extend along at least one of the upper portion 151, middle portion 153, and the lower portion 155. For example, the second elongate first split path channel 137-2 and the second elongate second split path channel 138-2 may extend along the lower portion 155, middle portion 153 and the upper portion 151, as shown in FIG. 3.

In some examples, the one or more flow rerouting first split path channels 141-n for the first split path may include a second flow rerouting first split path channel 141-2 having a first end portion coupled to the second end portion of the second elongate first split path channel 137-2 and a second end portion opposite the first end portion. The second flow rerouting first split path channel 141-2 may be configured to reroute a flow of the coolant along the first split path at a third predetermined angle. In some examples, the third predetermined angle may be in a range of about 120 degrees to about 190 degrees. In other examples, the third predetermined angle may have any other suitable value.

In some examples, the second flow rerouting first split path channel 141-2 may be disposed in at least one of the upper portion 151, middle portion 153, and the lower portion 155. For example, the second flow rerouting first split path channel 141-2 may be disposed in the upper portion 151, as shown in FIG. 3. In some examples, the second flow rerouting first split path channel 141-2 may be disposed in at least one of the left portion 152, intermediate portion 154, and right portion 156. For example, the second flow rerouting first split path channel 141-2 may be disposed in the left portion 152, as shown in FIG. 3.

In some examples, the one or more flow rerouting second split path channels 142-n for the second split path may include a second flow rerouting second split path channel 142-2 having a first end portion coupled to the second end portion of the second elongate second split path channel 138-2 and a second end portion opposite the first end portion. The second flow rerouting second split path channel 142-2 may be configured to reroute a flow of the coolant along the second split path at a fourth predetermined angle. In some examples, the fourth predetermined angle may be in a range of about 120 degrees to about 190 degrees. In other examples, the fourth predetermined angle may have any other suitable value.

In some examples, the second flow rerouting second split path channel 142-2 may be disposed in at least one of the upper portion 151, middle portion 153, and the lower portion 155. For example, the second flow rerouting second split path channel 142-2 may be disposed in the upper portion 151, as shown in FIG. 3. In some examples, the second flow rerouting second split path channel 142-2 may be disposed in at least one of the left portion 152, intermediate portion 154, and right portion 156. For example, the second flow rerouting second split path channel 142-2 may be disposed in the right portion 156, as shown in FIG. 3.

In some examples, the elongate first split path channels 137-n may further include a third elongate first split path channel 137-3 having a first end portion coupled to the second end portion of the second flow rerouting first split path channel 141-2 and a second end portion opposite the first end portion. The elongate second split path channels 138-n may further include a third elongate second split path channel 138-3 having a first end portion coupled to the second end portion of the second flow rerouting second split path channel 142-2 and a second end portion opposite the first end portion.

In some examples, the third elongate first split path channel 137-3 and/or the third elongate second split path channel 138-3 may be disposed in at least one of the left portion 152, intermediate portion 154, and right portion 156. For example, the third elongate first split path channel 137-3 may be disposed in the left portion 152, and the third elongate second split path channel 138-3 may be disposed in the right portion 156, as shown in FIG. 3. In some examples, the third elongate first split path channel 137-3 and the third elongate second split path channel 138-3 may extend along at least one of the upper portion 151, middle portion 153, and the lower portion 155. For example, the third elongate first split path channel 137-3 and the third elongate second split path channel 138-3 may extend along the upper portion 151, middle portion 153 and the lower portion 155, as shown in FIG. 3.

In some examples, the one or more flow rerouting second split path channels 142-n for the second split path may include a third flow rerouting second split path channel 142-3 having a first end portion coupled to the second end portion of the third elongate second split path channel 138-3 and a second end portion opposite the first end portion. The third flow rerouting second split path channel 142-3 may be configured to reroute a flow of the coolant along the second split path at a fifth predetermined angle. In some examples, the fifth predetermined angle may be in a range of about 60 degrees to about 120 degrees. In other examples, the fifth predetermined angle may have any other suitable value.

In some examples, the third flow rerouting second split path channel 142-3 may be disposed in at least one of the upper portion 151, middle portion 153, and the lower portion 155. For example, the third flow rerouting second split path channel 142-3 may be disposed in the lower portion 155, as shown in FIG. 3. In some examples, the third flow rerouting second split path channel 142-3 may be disposed in at least one of the left portion 152, intermediate portion 154, and right portion 156. For example, the third flow rerouting second split path channel 142-3 may be disposed in the right portion 156, as shown in FIG. 3.

The elongate second split path channels 138-n may further include a fourth elongate second split path channel 138-4 having a first end portion coupled to the second end portion of the third flow rerouting second split path channel 142-3 and a second end portion opposite the first end portion. In some examples, the fourth elongate second split path channel 138-4 may extend along at least one of the left portion 152, intermediate portion 154, and right portion 156. For example, the fourth elongate second split path channel 138-4 may extend along the right portion 156, intermediate portion 154, and left portion 152, as shown in FIG. 3. In some examples, the fourth elongate second split path channel 138-4 may be disposed in at least one of the upper portion 151, middle portion 153, and the lower portion 155. For example, the fourth elongate second split path channel 138-4 may be disposed in the lower portion 155, as shown in FIG. 3.

In some examples, the outlet channel 131-2 may include multiple outlet channels for multiple flow paths, each coupled to one of the split path channels. For example, referring to FIG. 4B, the outlet channel 131-2 may include a first outlet channel 131-2_{P1} coupled to one of the first split path channels (e.g., second end portion of the third elongate first split path channel 137-3) and a second outlet channel 131-2_{P2} coupled to one of the second split path channels (e.g., second end portion of the fourth elongate second split path channel 138-4).

In some examples, the first outlet channel 131-2_{P1} and/or the second outlet channel 131-2_{P2} may have a substantially constant width. That is, the width of the first outlet channel 131-2_{P1} and/or the second outlet channel 131-2_{P2} may be substantially uniform throughout its length. In some examples, a width of the first outlet channel 131-2_{P1} may be substantially the same as a width of the second outlet channel 131-2_{P2}. In other examples, the width of the first outlet channel 131-2_{P1} may be different from the width of the second outlet channel 131-2_{P2}.

In some examples, the first outlet channel 131-2_{P1} may extend in a first direction 191 and the second outlet channel 131-2_{P2} may extend in a second direction 192. An angle 193 may be formed between the first direction 191 and the second direction 192. In some examples, the angle 193 formed between the first outlet channel and the second outlet channel may be in a range of about 45° to about 120°. In some examples, the outlet channel 131-2 may be in a V-shape. In other examples, the outlet channel 131-2 may have any other suitable shape.

In some examples, the outlet channel 131-2 may define a virtual line 195 at which the first outlet channel 131-2_{P1} and the second outlet channel 131-2_{P2} may meet. In some example, the outlet port 105 may be disposed on the virtual line 195.

In some examples, the cooling channel 130 may further include one or more connector channels disposed between the inlet channel 131-1 and the splitting channel 135. The one or more connector channels may include one or more elongate connector channels 133-n and one or more flow rerouting connector channels 134-n.

In some examples, the one or more elongate connector channels 133-n may include a first elongate connector channel 133-1. The first elongate connector channel 133-1 may have a first end portion coupled to the inlet channel 131-1 and a second end portion opposite the first end portion. In some examples, the first elongate connector channel 133-1 may extend along at least one of the left portion 152, intermediate portion 154, and right portion 156. For example, the first elongate connector channel 133-1 may extend along the left portion 152 and intermediate portion 154, as shown in FIG. 3. In some examples, the first elongate connector channel 133-1 may be disposed in at least one of the upper portion 151, middle portion 153, and the lower portion 155. For example, the first elongate connector channel 133-1 may be disposed in the upper portion 151, as shown in FIG. 3.

In some examples, the one or more flow rerouting connector channels 134-n may include a first flow rerouting connector channel 134-1. The first flow rerouting connector channel 134-1 may have a first end portion coupled to the second end portion of the first elongate connector channel 133-1 and a second end portion coupled to the split inlet channel portion 135-1. The first flow rerouting connector channel 134-1 may be configured to reroute a flow of the coolant along the flow path at a sixth predetermined angle. In some examples, the sixth predetermined angle may be in a range of about 60 degrees to about 120 degrees. In other examples, the sixth predetermined angle may have any other suitable value.

In some examples, the first flow rerouting connector channel 134-1 may be disposed in at least one of the left portion 152, intermediate portion 154, and right portion 156. For example, the first flow rerouting connector channel 134-1 may be disposed in the intermediate portion 154, as shown in FIG. 3. In some examples, the first flow rerouting connector channel 134-1 may be disposed in at least one of the upper portion 151, middle portion 153, and the lower portion 155. For example, the first flow rerouting connector channel 134-1 may be disposed in the upper portion 151, as shown in FIG. 3.

In some examples, a width of the one or more connector channels may be narrower than a width of at least one of the elongate first split path channels 137-n. For example, a width of the first elongate connector channel 133-1 may be narrower than a width of the first elongate first split path channel 137-1, second elongate first split path channel 137-2, and/or third elongate first split path channel 137-3.

In some examples, a width of the one or more connector channels may be narrower than a width of at least one of the elongate second split path channels 138-n. For example, a width of the first elongate connector channel 133-1 may be narrower than a width of the first elongate second split path channel 138-1, second elongate second split path channel 138-2, third elongate second split path channel 138-3, and/or fourth elongate second split path channel 138-4.

In some examples, the inlet channel 131-1 may be defined as any portion of the cooling channel 130 disposed upstream of the splitting channel 135 (e.g., between the first end portion and the splitting channel 135). In this case, the one or more elongate connector channels 133-n and one or more flow rerouting connector channels 134-n may be part of the inlet channel 131-1.

In some examples, one or more splitting channels may be provided between the first split path channels. In this case, the first split path may be further divided into multiple split paths. In some examples, one or more splitting channels may be provided between the second split path channels. In this case, the second split path may be further divided into multiple split paths. In some examples, no splitting channel is provided between the inlet channel 131-1 and the splitting channel 135 and/or between the connector channels.

In some examples, a total volume of the cooling channel along the second split path (e.g., along the second split path channels 138-n, 142-n) may be greater than a total volume of the cooling channel along the first split path (e.g., along the first split path channels 137-n, 141-n). In other examples, the total volume of the cooling channel along the second split path may be (substantially) the same as the total volume of the cooling channel along the first split path. When the distance along the second split path is greater than the distance along the first split path, the width of the channels along the first and second split paths may be adjusted so that the total volume of the cooling channel along the second split path becomes (substantially) the same as the total volume of the cooling channel along the first split path. For example, when the distance along the second split path is greater than the distance along the first split path, the first split path channels may be designed to have a width greater than the width of the second split path channels.

In some examples, the cooling channel 130 may include one or more indentations. A portion of the cooling channel having the indentation may have a narrower width than other portions of the cooling channel.

Referring to FIG. 4C, in some examples, the elongate first split path channels 137-n and/or the elongate second split path channels 138-n may include one or more indentations. For example, the second end portion of the first elongate first split path channel 137-1 may include an indentation 181-1 and be tapered to have a narrower width toward the first flow rerouting first split path channel 141-1. Therefore, a width Wₚ₁ of a portion of the first elongate first split path channel 137-1 without the indentation may be greater than a narrowest width W_{T1} of the second end portion of the first elongate first split path channel 137-1.

In some examples, the indentation 181-1 may be formed only on a portion of the second end portion of the first elongate first split path channels 137-1 that is closer to a central axis 141-1_{C} of the first flow rerouting first split path channel 141-1, as shown in FIG. 4C. In other examples, the indentation may be formed on any other suitable portion of the first elongate first split path channels 137-1 (e.g., on a portion of the second end portion of the first elongate first split path channels 137-1 that is farther from the central axis 141-1_{C}).

In some examples, the first flow rerouting first split path channel 141-1 may include one or more indentations. For example, the first end portion of the first flow rerouting first split path channel 141-1 that is coupled to the first elongate first split path channels 137-1 may include an indentation (e.g., near a portion closer to the central axis 141-1_{C} thereof). In other examples, the indentation may be formed on any other suitable portion of the first flow rerouting first split path channel 141-1 (e.g., near a portion farther from the central axis 141-1_{C} thereof).

In some examples, the second end portion of the first elongate second split path channel 138-1 may include an indentation 182-1 and be tapered to have a narrower width toward the first flow rerouting second split path channel 142-1. Therefore, a width Wₚ₂ of a portion of the first elongate second split path channel 138-1 without the indentation may be greater than a narrowest width W_{T2} of the second end portion of the first elongate second split path channel 138-1.

In some examples, the indentation 182-1 may be formed only on a portion of the second end portion of the first elongate second split path channels 138-1 that is closer to a central axis 142-1_{C} of the first flow rerouting second split path channel 142-1, as shown in FIG. 4C. In other examples, the indentation may be formed on any other suitable portion of the first elongate second split path channels 138-1 (e.g., on a portion of the second end portion of the first elongate second split path channels 138-1 that is farther from the central axis 142-1_{C}).

In some examples, the first flow rerouting second split path channel 142-1 may include one or more indentations. For example, the first end portion of the first flow rerouting second split path channel 142-1 that is coupled to the first elongate second split path channels 138-1 may include an indentation (e.g., near a portion closer to the central axis 142-1_{C} thereof). In other examples, the indentation may be formed on any other suitable portion of the first flow rerouting second split path channel 142-1 (e.g., near a portion farther from the central axis 142-1_{C} thereof).

In some examples, other elongate first split path channels 137-n, elongate second split path channels 138-n, flow rerouting first split path channels 141-n, and/or flow rerouting second split path channels 142-n may have one or more indentations, for example, at a location similar to the first elongate first split path channel 137-1, first elongate second split path channel 138-1, first flow rerouting first split path channel 141-1, and/or first flow rerouting second split path channel 142-1 described above (e.g., at a second end portion of the elongate first split path channels 137-n and/or elongate second split path channels 138-n, and at a first end portion of the flow rerouting first split path channels 141-n and/or flow rerouting second split path channels 142-n) and duplicate description is omitted. The indentations may be provided to minimize flow stagnation near the corner of the cooling channel 130 where the flow of the coolant is rerouted.

In some examples, the cooling plate assembly 100 may include one or more supporting protrusions 170 in the cooling channel 130. The one or more supporting protrusions 170 may extend between the top plate 110 and the bottom plate 120.

In some examples, the supporting protrusions 170 may be arranged in a staggered pattern along the cooling channel 130. In other examples, the supporting protrusions 170 may be arranged in any other suitable pattern (e.g., grid pattern, random pattern).

In some examples, no supporting protrusion may be formed in at least one of the inlet channel 131-1 and one or more connector channels (e.g., connector channels 133-n, 134-n). In some examples, no supporting protrusion may be formed in any channel disposed upstream of the splitting channel 135. In some examples, no supporting protrusion may be formed near the inlet port 101, for example, within a predetermined distance from the inlet port 101. The predetermined distance may be in a range of about 450 mm to about 650 mm. In some examples, no supporting protrusion may be formed near the outlet port 105, for example, within a predetermined distance from the outlet port 105. The predetermined distance may be in a range of about 150 mm to about 250 mm. In other examples, one or more supporting protrusions may be formed in or near the inlet port 101 and/or the outlet port 105.

In some examples, the splitting channel 135 may include one or more supporting protrusions. In some examples, at least one of the one or more supporting protrusions in the splitting channel 135 may be disposed on the central axis 135_{C} of the splitting channel 135. For example, referring back to FIG. 4A, the split body channel portion 135-2 may include one or more supporting protrusions on the central axis 135_{C} of the splitting channel 135 (e.g., in a center portion of the split body channel portion 135-2).

In some examples, the one or more supporting protrusions 170 may be made of metals, metal alloys, and/or non-metallic materials (e.g., ceramics or carbon-based materials). For example, the one or more supporting protrusions 170 may be made of aluminum alloys. In other examples, the one or more supporting protrusions 170 may be made of any other suitable material (e.g., any other thermally conductive material). In some examples, the cross-sectional area of the one or more supporting protrusions 170 may have a circular shape. In other examples, the cross-sectional area of the one or more supporting protrusions 170 may have any other suitable shape (e.g., square, rectangular, triangle, etc.).

In some examples, a diameter of the one or more supporting protrusions 170 may be in a range of about 6.0 mm to about 28.0 mm. In other examples, the one or more supporting protrusions 170 may have any other suitable diameter. Although “diameter” is used herein for simplicity, there is no requirement that the one or more supporting protrusions 170 have a circular cross-section. In some examples, a height of the one or more supporting protrusions 170 (e.g., in the direction of the third axis) may be in a range of about 2.0 mm to about 5.0 mm. In other examples, the one or more supporting protrusions 170 may have any other suitable height.

The one or more supporting protrusions 170 may provide more structural rigidity, thereby strengthening the entire cooling plate assembly. This may also enable the cooling plate assembly 100 to withstand high internal operating pressures. In some examples, the cooling plate assembly 100 may be able to withstand a predetermined internal pressure, which is in a range of about 175 kPa to about 200 kPa.

In addition, the one or more supporting protrusions 170 may provide more surface area for heat transfer from the top plate 110/the bottom plate 120 to the coolant. Moreover, the one or more supporting protrusions 170 may be positioned for better mixing of the coolant and minimizing stagnation of the coolant.

In some examples, the top plate 110 may be bonded to the bottom plate 120 through a laser bonding process. In other examples, the top plate 110 may be bonded/attached to the bottom plate 120 through any other suitable bonding/welding/attaching process. In some examples, the top plate 110 and the bottom plate 120 may be bonded/attached to each other through the one or more supporting protrusions 170. For example, one end portion of the one or more supporting protrusions 170 may be bonded/attached to the top plate 110 and the other end portion of the one or more supporting protrusions 170 may be bonded/attached to the bottom plate 120.

Referring to FIGS. 4D-4F, in some examples, the inlet channel 131-1 may include a deep recess portion 121 having a depth deeper than a depth of other portions of the cooling channel. As described above, the cooling channel 130 may be formed on the bottom plate 120 (e.g., by forming a groove on the bottom plate 120), and a depth of the cooling channel 130 (without the deep recess portion 121) may be in a range of about 1.0 mm to about 5.0 mm. In other examples, the cooling channel 130 (without the deep recess portion 121) may have any other suitable depth value. As used herein, a depth of any portion of a cooling channel 130 may refer to a distance between a bottom of the specific portion of the cooling channel 130 and the top plate, for example, along the third axis (e.g., z-axis).

In some examples, a depth D_{w1} of the deep recess portion 121 may be deeper than other portions of the cooling channel 130 by a first predetermined distance. The first predetermined distance may be in a range of about 1.0 mm to about 3 mm. In some examples, the depth D_{w1} of the deep recess portion 121 may be in a range of about 3.0 mm to about 6.0 mm. In other examples, the deep recess portion 121 may have any other suitable depth value.

In some examples, the deep recess portion 121 may include a slanted portion 123. Through the slanted portion 123, the depth of the cooling channel 130 may gradually change (e.g., decrease) from the deep recess portion 121 to the other portions of the cooling channel 130. In other examples, the deep recess portion 121 may include a stepped portion. Through the stepped portion, the depth of the cooling channel 130 may change abruptly from the deep recess portion 121 to the other portions of the cooling channel 130.

Referring to FIG. 4E, the top plate 110 may include a hole 111 in fluid communication with the inlet port 101. The hole 111 may be disposed between the inlet port 101 and the cooling channel 130. In some examples, the top plate 110 may further include an inlet extender 115. The inlet extender 115 may be a protrusion surrounding the hole 111 and extending from the hole 111, for example, in the direction of the third axis (e.g., z-axis).

The inlet extender 115 may help extend a (shortest) distance D_{W2} between the bottom of the deep recess portion 121 and the inlet port 101. For example, referring back to FIG. 1B, the inlet port 101 may include a first end portion 102 and a second end portion 103 closer to the cooling channel 130 than the first end portion 102. The inlet port 101 (e.g., second end portion 103) may be disposed on/within/around the top portion of the inlet extender 115. Therefore, the inlet extender 115 may help extend a (shortest) distance D_{W2} between the bottom of the deep recess portion 121 and the second end portion 103 of the inlet port 101.

In some examples, a height D_{W3} of the inlet extender 115 in the direction of the third axis may be in a range of about 3.0 mm to about 8.0 mm. In other examples, the inlet extender 115 may have any other suitable height. In some examples, the (shortest) distance D_{W2} between the bottom of the deep recess portion 121 and the inlet port 101 may be in a range of about 8.0 mm to about 14.0 mm.

In some examples, when viewed from a top (from the third axis), the second end portion 103 of the inlet port 101 may overlay the deep recess portion 121, as shown in FIG. 4D. The deep recess portion 121 and/or the inlet extender 115 may help reduce the pressure drop of the flow of the coolant near the inlet port 101. In some examples, a pressure drop between the inlet port 101/inlet channel 131-1 and the outlet port 105/outlet channel 131-2 may be less than 1.5 kPa, more preferably, less than 1.4 kPA, less than 1.3 kPA, or less than 1.2 kPA.

In some examples, a diameter of the inlet port 101 (e.g., second end portion 103) may be in a range of about 10 mm to about 14 mm. In other examples, the inlet port (e.g., second end portion 103) may have any other suitable diameter. In some examples, a ratio between the diameter of the inlet port 101 and the depth D_{w1} of the deep recess portion 121 may be in a range of about 1.0:0.2 to about 1.0:0.6, for example, about 1.0:0.3 to about 1.0:0.42. In some examples, a ratio between the diameter of the inlet port 101 and the (shortest) distance D_{W2} between the bottom of the deep recess portion 121 and the inlet port 101 may be in a range of about 1.0:0.5 to about 1.0:1.4, for example, about 1.0:0.8 to about 1.0:1.0. Although “diameter” is used herein for simplicity, there is no requirement that the inlet port 101 (and the outlet port 105) have a circular cross-section.

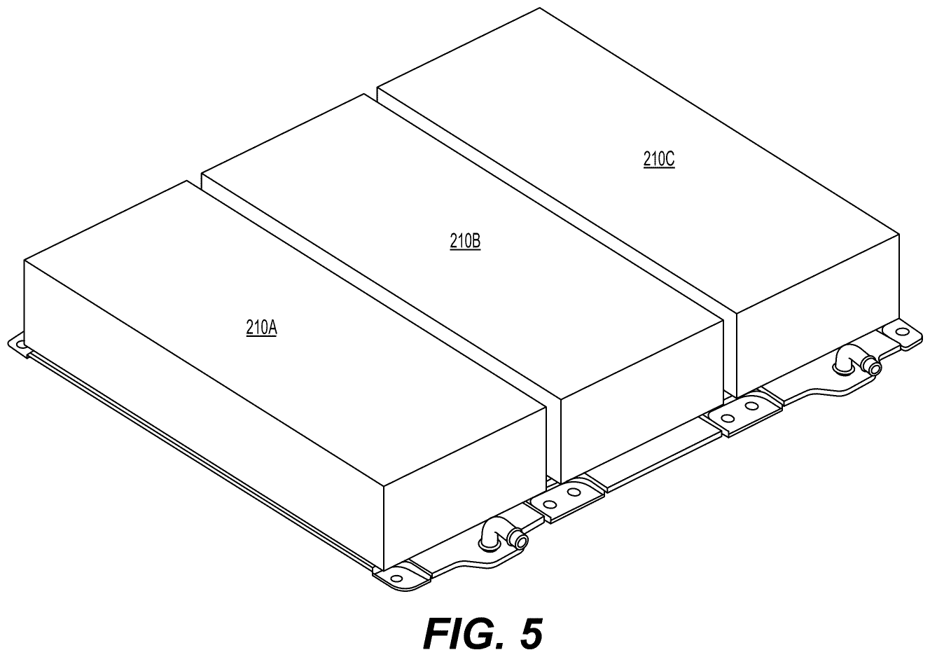

FIG. 5 illustrates a battery system (e.g., battery pack assembly) having battery units disposed on the cooling plate assembly 100. In some examples, the cooling plate assembly 100 may be shaped and sized to receive a plurality of battery units on the cooling plate assembly 100 to lower and/or maintain the temperature of the battery units. For example, as shown in FIG. 5, the cooling plate assembly 100 may be shaped and sized to receive a first battery unit 210A on the upper portion 151, a second battery unit 210B on the middle portion 153, and a third battery unit 210C on the lower portion 155. Although three battery units are shown in FIG. 5, there can be more or less than three battery units (e.g., 1, 2, 4, 5, 6, 7, 8, 9, 10, . . . ) on the cooling plate assembly 100.

In this arrangement, the configuration of the cooling channel 130 of the cooling plate assembly 100 may enable the coolant to flow vertically with respect to the battery units 210A-210C (e.g., along the first elongate first split path channel 137-1 and first elongate second split path channel 138-1) so that the initially cooler coolant can pass through the upper, middle, and lower portions before the temperature of the coolant rises significantly (e.g., over a predetermined temperature value) by the heat from the battery units 210A-210C. This configuration may enable the temperature to be more evenly maintained across the surfaces of the top plate or the portions of the cooling channel 130 that correspond respectively to the battery units 210A-210C, which may result in a more uniform cooling effect on the battery units.

In some examples, the cooling plate assembly 100 may be a thermal management plate assembly configured to decrease, increase, and/or maintain a temperature adjacent the thermal management plate assembly (e.g., temperature of adjacent devices). The thermal management plate assembly may include a top plate, a bottom plate, a channel disposed between the top plate and the bottom plate and configured to provide a flow path for a liquid, an inlet port coupled to the channel and configured to receive the liquid, and an outlet port coupled to the channel and configured to output the liquid. Examples of the liquid for the thermal management plate assembly may include water based coolants, mineral oils, synthetic fluids, thermal transfer fluids, and/or dielectric coolants. The configuration/feature/characteristic of the thermal management plate assembly (e.g., structure of the channel, materials of the components, indentations, supporting protrusions, deep recess portion, inlet extender, etc.) may be similar to and/or same as the ones described above with respect to the cooling plate assembly 100 and, thus, duplicate description is omitted.

### EXAMPLES

### Example 1

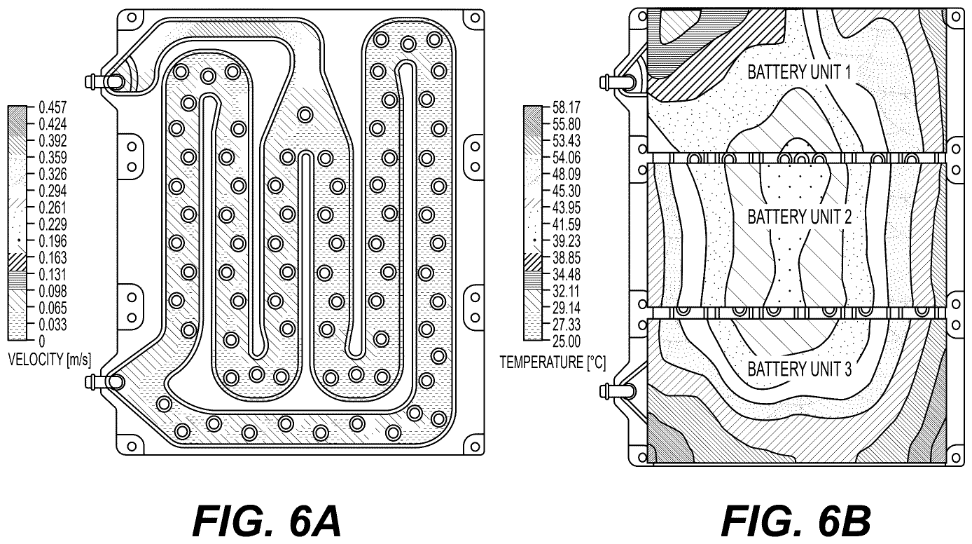

FIG. 6A is an example velocity map showing a change in the velocity of a coolant flow through a cooling channel of a cooling plate assembly according to an example of the present disclosure. FIG. 6B is an example heat map showing a change in temperature across battery units 1, 2, and 3 (during battery operation) disposed on an upper portion, a middle portion, and a lower portion, respectively, of a cooling plate assembly according to an example of the present disclosure. The average temperatures of battery unit 1, battery unit 2, and battery unit 3 are 43.83° C., 43.76° C., and 48.28° C., respectively.

As shown in FIG. 6A, indentations are formed near the corner of the cooling channel where the flow of the coolant is rerouted, and there is no or minimum flow stagnation in the portion of the cooling channel with the indentations. Also, the “V” shape of the outlet channel reduces flow stagnation at the outlet channel where the first split path and the second split path meet.

In addition, FIG. 6B shows generally uniform temperature distribution across the battery units 1, 2, 3. In particular, the average temperatures of the battery units 1, 2, 3 are similar, with only a small difference between them (e.g., around 4.5° C.).

### Example 2

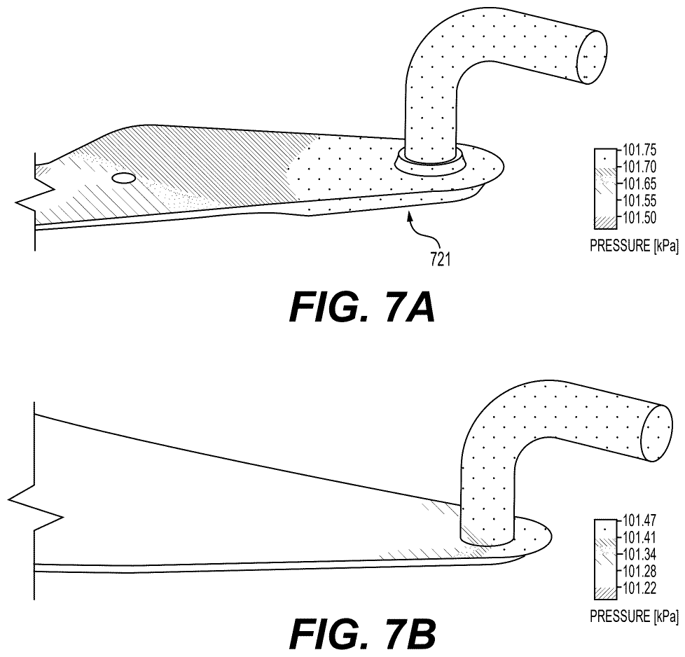

FIG. 7A is an example pressure map showing a change in pressure near an inlet channel of a cooling plate assembly according to an example of the present disclosure, where a deep recess portion 721 and an inlet extender 715 are provided near the inlet channel. FIG. 7B is an example pressure map showing a change in pressure near an inlet channel of a cooling plate assembly according to a comparative example, where no deep recess portion or inlet extender is provided near the inlet channel. As shown in FIGS. 7A and 7B, there is less pressure drop near the inlet port/inlet channel when a deep recess portion and an inlet extender are provided near the inlet channel.

### Example 3

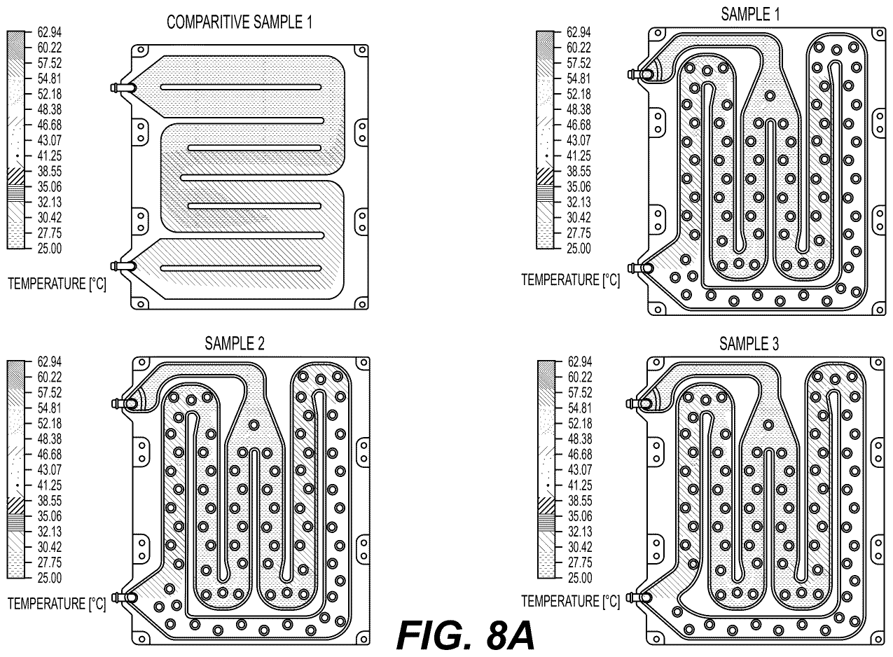

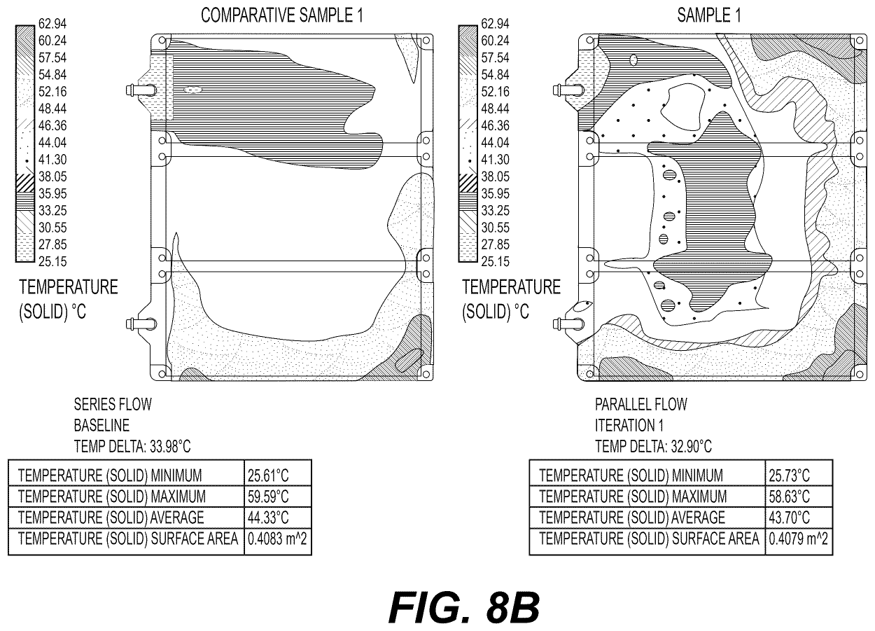

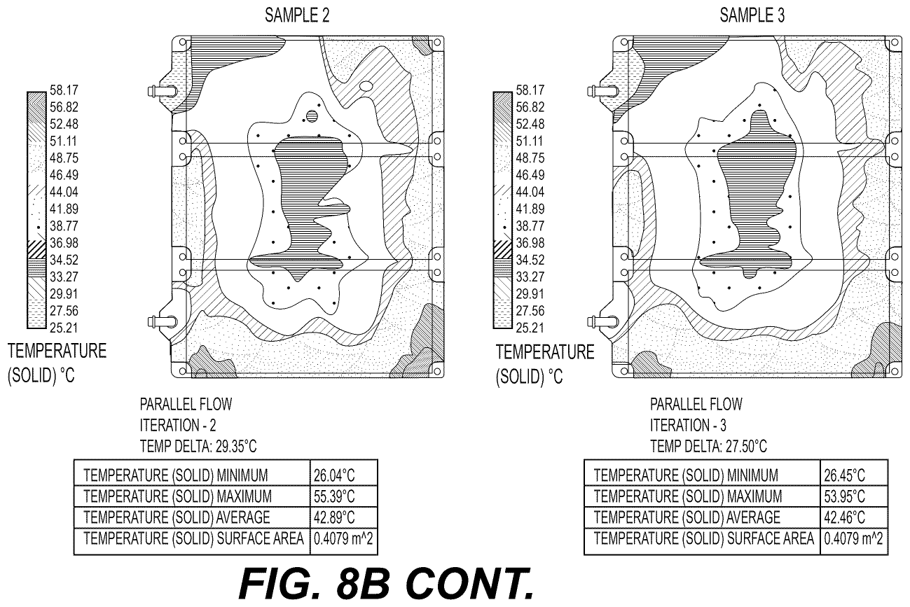

FIG. 8A illustrates example temperature maps showing a change in the temperature of a coolant/cooling channel of Comparative Sample 1 and Samples 1, 2, 3 according to an example of the present disclosure. FIG. 8B illustrates example temperature maps showing a change in the temperature of a top plate of Comparative Sample 1 and Samples 1, 2, 3 according to an example of the present disclosure. Although not shown, three battery units (e.g., battery units 1, 2, 3 in FIG. 6B) were disposed on the comparative sample and samples 1, 2, 3 on the upper portion, middle portion, and lower portion thereof and the temperature was measured while the battery units were under test operation. In addition, although not shown, a deep recess portion is formed in Samples 1, 2, and 3 (e.g., in the inlet channel thereof).

In Comparative Sample 1, the cooling channel has a series flow path, where the coolant passes the upper portion first on which a first battery unit 1 is disposed, then the middle portion on which a second battery unit 2 is disposed, and finally the lower portion on which a third battery unit 3 is disposed. As shown in FIGS. 8A and 8B, by the time the coolant reaches the lower portion for the first time, the temperature of the coolant is already high, which may cause the third battery unit 3 disposed on the lower portion to have a temperature much higher than the first and second battery units 1, 2.

As shown in FIG. 8A, in Sample 1, 2, and 3, the cooling channel allows the coolant to flow vertically with respect to the battery units 1, 2, 3 (e.g., along the first elongate first split path channel 137-1 and first elongate second split path channel 138-1) so that the initially cooler coolant can pass through the upper, middle, and lower portions before the temperature of the coolant rises significantly (e.g., over a predetermined temperature value) by the heat from the battery units 1, 2, 3. Relative to Comparative Sample 1, this may enable the temperature to be more evenly maintained across the surfaces of the top plate or the portions of the cooling channel that correspond respectively to the battery units, which may result in a more uniform cooling effect on the battery units. As shown in FIG. 8B, the difference between a maximum temperature and a minimum temperature on the top plate (“top plate temperature difference”) of Samples 1, 2, and 3 is lower than Comparative Sample 1. Samples 2 and 3 include indentations formed near the corner of the cooling channel where the flow of the coolant is rerouted. In Sample 3, the outlet channel has a V-shape. It is noted that the top plate temperature differences of Samples 2 and 3 having these additional features are significantly lower than that of Sample 1.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “width,” “length,” “thickness,” “depth,” “height”, and/or any similar measurements may refer to their average values. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

As used herein, “about,” “approximately,” “generally,” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 5, from 3 to 6, from 1 to 9, from 2.5 to 4.7, from 2.2 to 9.9, and so forth.

It is noted that the hereinafter-used terms “attachable”, “attached”, “connectable”, and “connected” include, respectively, directly or indirectly attachable, directly or indirectly attached, directly or indirectly connectable, and directly or indirectly connected.

When the position relation between two parts is described using the terms such as “on,” “above,” “below,” “under,” and “next,” one or more parts may be positioned between the two parts unless the terms are used with the term “immediately” or “directly.” Similarly, as used herein, the terms “attachable”, “attached”, “connectable”, “connected” or any similar terms may include directly or indirectly attachable, directly or indirectly attached, directly or indirectly connectable, and directly or indirectly connected.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

Additionally, in describing the components of the present invention, there may be terms used like first, second, A, B, (a), and (b). These may be for the purpose of differentiating one component from the other but not to imply or suggest the substances, order, sequence, or number of the components unless the context dictates otherwise.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cooling plate assembly comprising:
a top plate;
a bottom plate;
a cooling channel disposed between the top plate and the bottom plate and configured to provide a flow path for a coolant;
an inlet port coupled to the cooling channel and configured to receive the coolant; and
an outlet port coupled to the cooling channel and configured to output the coolant,
wherein the cooling channel comprises:
an inlet channel coupled to the inlet port;
an outlet channel coupled to the outlet port;
a splitting channel disposed downstream of the inlet channel and configured to divide the flow path into a first split path and a second split path;
a plurality of first split path channels disposed between the splitting channel and the outlet channel, wherein the first split path channels comprise:
a plurality of direct flow first split path channels; and
one or more flow rerouting first split path channels; and
a plurality of second split path channels disposed between the splitting channel and the outlet channel, wherein the second split path channels comprise:
a plurality of direct flow second split path channels; and
one or more flow rerouting second split path channels,
wherein the first split path and the second split path meet at the outlet channel,
wherein at least one of the direct flow first split path channels is substantially in parallel with at least one of the direct flow second split path channels, and
wherein a length of at least one of the direct flow second split path channels is greater than a length of a longest direct flow first split path channel among the direct flow first split path channels.

2. The cooling plate assembly of claim 1, wherein the cooling plate assembly defines, when viewed from a top:
an upper portion, a lower portion, and a middle portion between the upper portion and the lower portion; and
a left portion, a right portion, and an intermediate portion between the left portion and the right portion,
wherein the inlet port and the inlet channel are disposed in the upper portion and the left portion, and
wherein the outlet port and the outlet channel are disposed in the lower portion and the left portion.

3. The cooling plate assembly of claim 2,
wherein the direct flow first split path channels comprise a first direct flow first split path channel having a first end portion coupled to the splitting channel and a second end portion opposite the first end portion,
wherein the direct flow second split path channels comprise a first direct flow second split path channel having a first end portion coupled to the splitting channel and a second end portion opposite the first end portion,
wherein the splitting channel, the first direct flow first split path channel, and the first direct flow second split path channel are disposed in the intermediate portion, and
wherein the first direct flow first split path channel and the first direct flow second split path channel extend along the middle portion and the lower portion.

4. The cooling plate assembly of claim 3,
wherein the one or more flow rerouting first split path channels comprise a first flow rerouting first split path channel having a first end portion coupled to the second end portion of the first direct flow first split path channel and a second end portion opposite the first end portion, wherein the first flow rerouting first split path channel is configured to reroute a flow of the coolant along the first split path at a first predetermined angle,
wherein the one or more flow rerouting second split path channels comprise a first flow rerouting second split path channel having a first end portion coupled to the second end portion of the first direct flow second split path channel and a second end portion opposite the first end portion, wherein the first flow rerouting second split path channel is configured to reroute a flow of the coolant along the second split path at a second predetermined angle.
wherein the first flow rerouting first split path channel and the first flow rerouting second split path channel are disposed in the lower portion.

5. The cooling plate assembly of claim 4, wherein the first predetermined angle and the second predetermined angle are in a range of about 120 degrees to about 190 degrees.

6. The cooling plate assembly of claim 4,
wherein the second end portion of the first direct flow first split path channel is tapered to have a narrower width toward the first flow rerouting first split path channel, and
wherein the second end portion of the first direct flow second split path channel is tapered to have a narrower width toward the first flow rerouting second split path channel.

7. The cooling plate assembly of claim 4,
wherein the direct flow first split path channels comprise a second direct flow first split path channel having a first end portion coupled to the second end portion of the first flow rerouting first split path channel and a second end portion opposite the first end portion,
wherein the direct flow second split path channels comprise a second direct flow second split path channel having a first end portion coupled to the second end portion of the first flow rerouting second split path channel and a second end portion opposite the first end portion,
wherein the second direct flow first split path channel and the second direct flow second split path channel extend along the lower portion, the middle portion, and the upper portion.

8. The cooling plate assembly of claim 2, wherein the cooling plate assembly is shaped and sized to receive a first battery unit on the upper portion, a second battery unit on the middle portion, and a third battery unit on the lower portion.

9. The cooling plate assembly of claim 1, wherein the splitting channel defines a central axis, wherein an arrangement of the plurality of first split path channels and an arrangement of the plurality of second split path channels are asymmetrical with respect to the central axis of the splitting channel.

10. The cooling plate assembly of claim 1, further comprising a plurality of supporting protrusions disposed in the cooling channel and extending between the top plate and the bottom plate.

11. The cooling plate assembly of claim 10, wherein the plurality of supporting protrusions are arranged in a staggered pattern along the cooling channel.

12. The cooling plate assembly of claim 10, wherein the inlet channel does not include any supporting protrusion.

13. The cooling plate assembly of claim 10, wherein the splitting channel defines a central axis, wherein the splitting channel includes a supporting protrusion disposed on the central axis of the splitting channel.

14. The cooling plate assembly of claim 1,
wherein the outlet channel comprises a first outlet channel coupled to one of the first split path channels and a second outlet channel coupled to one of the second split path channels,
wherein the first outlet channel and the second outlet channel have a substantially constant width.

15. The cooling plate assembly of claim 14, wherein an angle formed between the first outlet channel and the second outlet channel is in a range of about 45° to about 120°.

16. The cooling plate assembly of claim 1,
wherein the inlet channel includes a deep recess portion having a depth deeper than a depth of other portions of the cooling channel,
wherein the inlet port comprises a first end portion and a second end portion closer to the cooling channel than the first end portion,
wherein, when viewed from a top, the second end portion of the inlet port overlays the deep recess portion of the inlet channel.

17. The cooling plate assembly of claim 16, wherein a ratio between a diameter of the inlet port and the depth of the deep recess portion is in a range of about 1.0:0.3 to about 1.0:0.42.

18. The cooling plate assembly of claim 1, wherein a shortest distance of the second split path channels along the second split path is greater than a shortest distance of the first split path channels along the first split path.

19. The cooling plate assembly of claim 1, wherein the cooling channel further comprises a connector channel disposed between the inlet channel and the splitting channel, wherein a width of the connector channel is narrower than a width of the direct flow first split path channels.

20. A thermal management plate assembly comprising:
a top plate;
a bottom plate;
a channel disposed between the top plate and the bottom plate and configured to provide a flow path for a liquid;
an inlet port coupled to the channel and configured to receive the liquid; and
an outlet port coupled to the channel and configured to output the liquid,
wherein the channel comprises:
an inlet channel coupled to the inlet port;
an outlet channel coupled to the outlet port;
a splitting channel disposed downstream of the inlet channel and upstream of the outlet channel, wherein the splitting channel is configured to divide the flow path into a first split path and a second split path;
a plurality of first split path channels disposed between the splitting channel and the outlet channel, wherein the first split path channels comprise:
a plurality of direct flow first split path channels; and
one or more flow rerouting first split path channels; and
a plurality of second split path channels disposed between the splitting channel and the outlet channel, wherein the second split path channels comprise:
a plurality of direct flow second split path channels; and
one or more flow rerouting second split path channels,
wherein the inlet channel includes a deep recess portion having a depth deeper than a depth of other portions of the channel,
wherein the inlet port comprises a first end portion and a second end portion closer to the channel than the first end portion,
wherein, when viewed from a top, the second end portion of the inlet port overlays the deep recess portion of the inlet channel.
